(19) United States
(12) Patent Application Publication
(10) Pub. No.: US 2024/0215492 A1
(43) Pub. Date: Jul. 4, 2024

(54) HIGH WATER-RETENTION AND DUST-SUPPRESSION CROP STRAW MULCHING METHOD AND CROP STRAW FORMING DIE

(71) Applicant: SHANXI AGRICULTURAL UNIVERSITY, Taiyuan (CN)

(72) Inventors: Xiaojuan WANG, Taiyuan (CN); Juanling WANG, Taiyuan (CN)

(21) Appl. No.: 18/316,514

(22) Filed: May 12, 2023

Related U.S. Application Data
(63) Continuation of application No. PCT/CN2023/070808, filed on Jan. 6, 2023.

(30) Foreign Application Priority Data
Dec. 30, 2022 (CN) 202211713357.5

(51) Int. Cl. A01D 82/02

(52) U.S. Cl. CPC A01D 82/02; A01G 2013/008

(57) ABSTRACT

A water-retention and dust-suppression crop straw mulching method includes crushing a whole harvested crop straw to be 1-4 cm in length first, mixing the crushed crop straw with an adhesive well, and uniformly paving the mixed crop straw into a forming die for extrusion forming to form crop straw modules. A plurality of drain holes is on the crop straw modules. The method includes stubble cleaning and subsoiling treatment on the harvested farmland, and then performing rotary cultivation on the farmland to loosen soil, and performing rolling treatment on the rotary-cultivated soil by a land roller; paving the crop straw modules on the farmland uniformly in a densely covered way, meanwhile, connecting and fixing the crop straw modules by ribbons and connecting rods. The method helps to block the upward evaporation channel of soil moisture, reduce the evaporation of soil moisture, prevent the crushed crop straw from polluting the environment.

### FIELD OF TECHNOLOGY

The present invention relates to a high water-retention and dust-suppression crop straw mulching method and a crop straw forming die, belonging to the technical field of crop soil moisture-conservation sowing.

### BACKGROUND

At present, crop straw mulching way includes whole straw mulching and crushed straw mulching. In windy days of spring and autumn, crushed crop straws from crushed straw mulching and partial crop straw leaves from whole straw mulching are easily blown away by wind, which flies all over the sky and pollutes the environment. Moreover, a portion of rainwater will be intercepted and absorbed by crop straws both from whole straw mulching and crushed straw mulching, resulting in reduced rainwater flowing into soil. Furthermore, there are gaps among crop straws both from whole straw mulching and crushed straw mulching, which will retain soil moisture not well.

### SUMMARY

To solve the technical problem existing in the prior art, the present invention provides a high water-retention and dust-suppression crop straw mulching method and a crop straw forming die which are capable of effectively blocking the upward evaporation channel of soil moisture, reducing the evaporation of soil moisture, preventing the crushed crop straw from polluting the environment and being convenient for the treatment of crop straw.

To achieve the above objectives, the technical solution applied to the present invention is a high water-retention and dust-suppression crop straw mulching method, where the method is implemented according to the following steps of:
a, production of crop straw modules
crushing a whole harvested crop straw to be 1-4 cm in length first, mixing the crushed crop straw with an adhesive well according to a mixing ratio of 1:0.0001-0.0005, and finally uniformly paving the mixed crop straw into a forming die for extrusion forming to form the crop straw modules, where a plurality of drain holes are reserved on the crop straw modules;
b, farmland shaping
performing stubble cleaning and subsoiling treatment on the harvested farmland, performing rotary cultivation on the farmland to loosen soil, and finally performing rolling treatment on the rotary-cultivated soil by a land roller;
c, pavement of the crop straw modules
uniformly paving the crop straw modules on the farmland after being treated by the step b in a densely covered way, meanwhile, connecting and fixing the crop straw modules by ribbons and connecting rods until the farmland is carpeted with the crop straw modules.

Preferably, a top surface of each of the crop straw modules is a down-sunk arc-shaped structure; the drain holes are uniformly disposed on surfaces of the crop straw modules, and the crop straw modules have a thickness of 0.8-5 cm.

Preferably, the adhesive is a soybean protein adhesive.

Preferably, in the step a, during the production of the crop straw modules, a plurality of insertion holes are disposed on end faces around the crop straw modules, respectively; the adjacent crop straw modules are connected via the connecting rods inserted into the insertion holes.

A crop straw forming die applied to the high water-retention and dust-suppression crop straw mulching is provided, including an upper die pressure head and a lower die box matched with the upper die pressure head, where the lower die box includes a die base plate, die side plates and a positioning box; folded plates are disposed at the bottom of the positioning box; the die base plate is mounted in a box enclosed by the four folded plates; sliding seats are mounted around inner walls of the positioning box, respectively; guide rails are disposed on the back of the die side plates, and the guide rails are mounted on the sliding seats, and the four die side plates enclose a box and are disposed on the die base plate; a plurality of perforated columns are further mounted on the die base plate, and correspondingly, a plurality of sockets are disposed on the upper die pressure head; the perforated columns are configured to be inserted into the sockets.

Preferably, a bottom surface of the upper die pressure head is an arc-shaped bulge with a bulged pressure head surface.

Preferably, the sliding seats are T-shaped chutes, and correspondingly, the guide rails are T-shaped guide rails.

Preferably, a degradable plastic film is disposed on the die side plates and the die base plate.

Compared with the prior art, the present invention has the following technical effects: in this present invention, crop straw is crushed and extruded to form crop straw modules; the compressed crop straw can block the upward evaporation channel of soil moisture better than simple crop straw mulching, reduce the evaporation of soil moisture and can prevent crushed crop straw and soil particles from being blown away by wind, resulting in environmental pollution. Moreover, the slope formed during the compression and reserved holes collect rainwater or thawed snow water, making it flowing into the farmland, which reduces the absorption of crop straw on rainwater itself, increases the soil moisture content, and thus is beneficial to the crop seedling emergence and growth in drought years.

### BRIEF DESCRIPTION OF THE DRAWINGS

FIG. 1 is a structure diagram showing a crop straw forming die in the present invention.

### DETAILED DESCRIPTION OF THE EMBODIMENTS

To make the technical problems to be solved by the present invention, technical solution and beneficial effects more clearly and apparently, the present invention will be further described in detail with reference to the accompanying drawings and embodiments below. It should be understood that detailed embodiments described here are merely used to explain the present invention, but are not construed as limiting the present invention.

A high water-retention and dust-suppression crop straw mulching method was implemented according to the following steps:
a, production of crop straw modules: a whole harvested crop straw was crushed to be 1-4 cm in length first, the crushed crop straw was mixed with an adhesive well according to a mixing ratio of 1:0.0001-0.0005, finally the mixed crop straw was uniformly paved into a forming die for extrusion forming to form the crop straw modules, where a plurality of drain holes were reserved on the crop straw modules; a plurality of insertion holes were opened on end faces around the crop straw modules via a punching equipment;
b, farmland shaping: stubble cleaning and subsoiling treatment were performed on the harvested farmland, rotary cultivation was performed on the farmland to loosen soil, and finally rolling treatment was performed on the rotary-cultivated soil by a land roller;
c, pavement of the crop straw modules: the crop straw modules were uniformly paved on the farmland after being treated by the step b in a densely covered way, meanwhile, the crop straw modules were connected and fixed by ribbons and connecting rods until the farmland was carpeted with the crop straw modules; during connection, the connecting rods were inserted into the insertion holes of the adjacent crop straw modules, and the connecting rods were made of crop straw or a wooden stick.

The crop straw modules are extruded and formed via a crop straw die; a top surface of each of the molded crop straw modules is a down-sunk arc-shaped structure; the drain holes are uniformly disposed on surfaces of the crop straw modules, and the crop straw modules have a thickness of 0.8-5 cm. In this way, the crop straw modules may collect rain and snow when paved on the ground, and may make rainwater and thawed snow flowing into soil through the drain holes for rainwater collection. The crop straw modules have a thickness of 0.8-5 cm; and the thickness may be chosen according to the amount of the crop straw and local climate. During the pavement of the crop straw modules, a plurality of crop straw modules are connected and fixed together via ribbons bound on the drain holes of the crop straw modules. This configuration may prevent the crop straw modules from being blown away in high wind. The adhesive is a soybean protein adhesive convenient for module degradation.

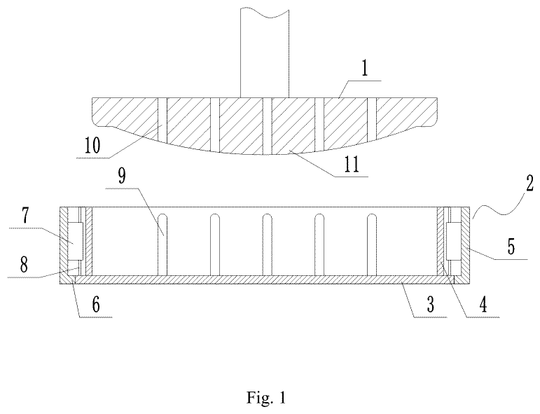

As shown in FIG. 1, a high water-retention and dust-suppression crop straw crop straw forming die includes an upper die pressure head 1 and a lower die box 2 matched with the upper die pressure head 1; the lower die box 2 includes a die base plate 3, die side plates 4 and a positioning box 5; folded plates 6 are disposed at the bottom of the positioning box 5; the die base plate 3 is mounted in a box enclosed by the four folded plates 6; sliding seats 7 are mounted around inner walls of the positioning box 5, respectively; guide rails 8 are disposed on the back of the die side plates 4, and the guide rails 8 are mounted on the sliding seats 7, and the four die side plates 4 enclose a box and are disposed on the die base plate 3; a plurality of perforated columns 9 are further mounted on the die base plate 3, and correspondingly, a plurality of sockets 10 are disposed on the upper die pressure head 1; the perforated columns 9 are configured to be inserted into the sockets 10.

An integrated structure is applied to the crop straw forming die; the lower die box is limited by the positioning box and locates the die side plates; the die base plate is mounted inside the positioning box and four die side plates are mounted on the sliding seats via guide rails, and the enclosed box is placed on the die base plate; the die side plates and the guide rails are located within the scope of the die base plate. The lower die box is a box die having a thickness of 0.5-2 m and a width of 0.5-2 m.

In use, the die base plate is fixed and the positioning box is mounted outside the die base plate; flying rings are connected on the positioning box convenient for hoisting. The die side plates are then mounted. At the end of assembly, a degradable plastic film is paved on the die base plate and die side plates, crop straw chippings are then paved, and the upper die pressure head is used for compaction after the pavement. A bottom surface of the upper die pressure head 1 is an arc-shaped bulge 11 with a bulged pressure head surface such that the top surface of each crop straw module forms a groove convenient for water connection. After extrusion forming, the positioning box is taken down first, the die side plates are then disassembled, and finally the compacted crop straw modules are removed. The sliding seats 7 are T-shaped chutes, and correspondingly, the guide rails 8 are T-shaped guide rails, which is convenient for the installation and disassembly of the die side plates.

What is described above are merely preferred embodiments but are not construed as limiting the present invention. Any amendment, equivalent replacement, improvement and the like made within the spirit and principle of the present invention shall fall within the scope of the present invention.

1. A high water-retention and dust-suppression crop straw mulching method, wherein the method is implemented according to the following steps of:
a, production of crop straw modules
crushing a whole harvested crop straw to be 1-4 cm in length first, mixing the crushed crop straw with an adhesive well according to a mixing ratio of 1:0.0001-0.0005, and finally uniformly paving the mixed crop straw into a forming die for extrusion forming to form the crop straw modules, wherein a plurality of drain holes are reserved on the crop straw modules;
b, farmland shaping
performing stubble cleaning and subsoiling treatment on the harvested farmland, performing rotary cultivation on the farmland to loosen soil, and finally performing rolling treatment on the rotary-cultivated soil by a land roller;
c, pavement of the crop straw modules
uniformly paving the crop straw modules on the farmland after being treated by the step b in a densely covered way, meanwhile, connecting and fixing the crop straw modules by ribbons and connecting rods until the farmland is carpeted with the crop straw modules, and at the end of the pavement, performing rolling treatment on the crop straw modules by a land roller.

2. The high water-retention and dust-suppression crop straw mulching method according to claim 1, wherein a top surface of each of the crop straw modules is a down-sunk arc-shaped structure; the drain holes are uniformly disposed on surfaces of the crop straw modules, and the crop straw modules have a thickness of 0.8-5 cm.

3. The high water-retention and dust-suppression crop straw mulching method according to claim 1, wherein the adhesive is a soybean protein adhesive.

4. The high water-retention and dust-suppression crop straw mulching method according to claim 1, wherein in the step a, during the production of the crop straw modules, a plurality of insertion holes are disposed on end faces around the crop straw modules, respectively; the adjacent crop straw modules are connected via the connecting rods inserted into the insertion holes.

5. A crop straw forming die applied to the high water-retention and dust-suppression crop straw mulching method according to claim 1, comprising an upper die pressure head and a lower die box matched with the upper die pressure head, wherein the lower die box comprises a die base plate, die side plates and a positioning box; folded plates are disposed at the bottom of the positioning box; the die base plate is mounted in a box enclosed by the four folded plates; sliding seats are mounted around inner walls of the positioning box, respectively; guide rails are disposed on the back of the die side plates, and the guide rails are mounted on the sliding seats, and the four die side plates enclose a box and are disposed on the die base plate; a plurality of perforated columns are further mounted on the die base plate, and correspondingly, a plurality of sockets are disposed on the upper die pressure head; the perforated columns are configured to be inserted into the sockets.

6. The high water-retention and dust-suppression crop straw forming die according to claim 5, wherein a bottom surface of the upper die pressure head is an arc-shaped bulge with a bulged pressure head surface.

7. The high water-retention and dust-suppression crop straw forming die according to claim 5, wherein the sliding seats are T-shaped chutes, and correspondingly, the guide rails are T-shaped guide rails.

8. The high water-retention and dust-suppression crop straw forming die according to claim 5, wherein a degradable plastic film is disposed on the die side plates and the die base plate.
